(19) United States
(12) Patent Application Publication
(10) Pub. No.: US 2026/0145629 A1
(43) Pub. Date: May 28, 2026

(54) REINFORCEMENT PLATES FOR PROTECTING A BUMPER COVER OF A VEHICLE

(71) Applicant: Toyota Motor Engineering & Manufacturing North America, Inc., Plano, TX (US)

(72) Inventors: Aaron R. Steinhilb, Milan, MI (US); Timothy J. Woychowski, Fenton, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/956,772

(22) Filed: Nov. 22, 2024

(51) Int. Cl. B60R 19/44

(52) U.S. Cl. CPC B60R 19/44

(57) ABSTRACT

A reinforcement plate for protecting a bumper cover of a vehicle includes a base wall configured to be disposed below the bumper cover and a mounting bracket extending from the base wall and configured to be mounted to a chassis of the vehicle. The reinforcement plate further includes a plurality of ribs each extending between and connected to the base wall and the mounting bracket for supporting a position of the base wall relative to the mounting bracket.

### TECHNICAL FIELD

The present specification generally relates to reinforcement plates for vehicles and, more specifically, reinforcement plates for protecting a bumper cover of a vehicle.

### BACKGROUND

The use of vehicles on off-road trails is a hobby for many vehicle operators. Bumper covers having a desired aesthetic design are provided at the front and rear of the vehicle. The bumper covers are often susceptible to damage from impact when the vehicle travels on off-road trails. Depending on the topography of the terrain, the bumper covers may contact the ground due to the approach and departure angles of the vehicle. The approach and departure angles refer to the steepest angle at which the vehicle can move onto and off-of an inclined surface, respectively, without the vehicle hitting the inclined surface. The approach and departure angles of the vehicles are often maximized for on-road compliance rather than off-road capability, which increase the chance of contact between the bumper covers and the ground.

To prevent damage to the bumper covers, vehicle operators have replaced the bumpers covers and the steel bumper that attach directly to the frame of the vehicle. While effective, the steel bumpers are a costly and permanent replacement that changes the aesthetics of the vehicle.

Accordingly, a need exists for alternative reinforcement plates for protecting a bumper cover of a vehicle.

### SUMMARY

In one embodiment, a reinforcement plate for protecting a bumper cover of a vehicle may include a base wall configured to be disposed below the bumper cover, a mounting bracket extending from the base wall and configured to be mounted to a chassis of the vehicle, and a plurality of ribs each extending between and connected to the base wall and the mounting bracket for supporting a position of the base wall relative to the mounting bracket.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a vehicle having a bumper cover and a pair of reinforcement plates, according to one or more embodiments shown and described herein;

FIG. 2 schematically depicts a top perspective view of one of the pair of reinforcement plates of FIG. 1, according to one or more embodiments shown and described herein; and

FIG. 3 schematically depicts a bottom perspective view of the reinforcement plate of FIG. 2, according to one or more embodiments shown and described herein.

### DETAILED DESCRIPTION

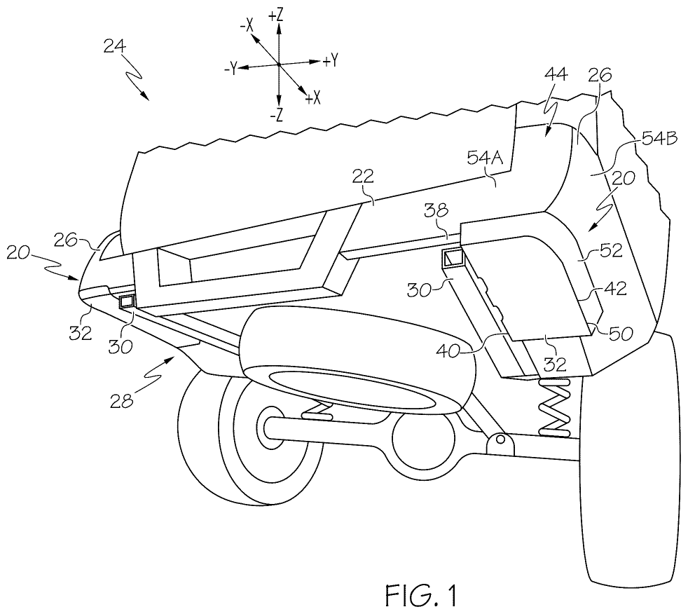

FIG. 1 generally depicts a reinforcement plate for protecting a bumper cover of a vehicle. The reinforcement plate serves as a barrier that prevents contact between the bumper cover and the ground during off-road use of the vehicle. The reinforcement plate includes a base wall configured to be disposed below the bumper cover and a mounting bracket extending from the base wall and configured to be mounted to a chassis of the vehicle. The reinforcement plate further includes a plurality of ribs each extending between and connected to the base wall and the mounting bracket for supporting the position of the base wall relative to the mounting bracket.

Previous ways of preventing damage to the bumper cover involved removing the bumper cover and installing a steel bumper in its place. However, the steel bumper is the steel bumpers are a costly and permanent replacement that also changes the aesthetics of the vehicle. The embodiments described herein provides the reinforcement plate configured to be mounted to a chassis of the vehicle without removing the bumper cover. The base wall is disposed below the bumper cover, protecting the bumper cover from contact with the ground during off-road use. The mounting of the reinforcement plate to the chassis creates a load path directly to the chassis, reducing a load experienced by the bumper cover when contact is made with the ground. Furthermore, the reinforcement plate is smaller and lighter than a steel bumper replacement, which reduces the overall weight of the vehicle. Moreover, the size of the reinforcement plate allows it to be installed and removed based on need. As such, the reinforcement plate may be installed for off-road use and then removed after off-road use. Furthermore, the placement of the base wall of the reinforcement plate under the bumper cover allows the bumper cover to be visible and maintain the aesthetic qualities of the vehicle. Various embodiments and benefits of the reinforcement plate will be described in more detail herein.

As used herein, the term “vehicle longitudinal direction” refers to the forward-rearward direction of the vehicle (i.e., in the +/−X direction of the coordinate axes depicted in FIG. 1). The term “vehicle lateral direction” refers to the cross-vehicle direction (i.e., in the +/−Y direction of the coordinate axes depicted in FIG. 1), and is transverse to the vehicle longitudinal direction. The term “vehicle vertical direction” refers to the upward-downward direction of the vehicle (i.e., in the +/−Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings.

Referring now to FIG. 1, a vehicle 24 is provided with a pair of reinforcement plates 20 for protecting a bumper cover 22 of the vehicle 24, in accordance with one or more embodiments of the present disclosure. The bumper cover 22 shown in FIG. 1 is disposed at a rear end of the vehicle 24. However, the pair of reinforcement plates 20 may be configured to protect a bumper cover disposed at a front end of the vehicle 24.

The bumper cover 22 may cover (and thus hide) an attenuation system that absorbs an impact to the vehicle 24. As such, the bumper cover 22 provides an aesthetic appearance to the vehicle 24. The bumper cover 22 may be formed of a polymer, a sheet metal, a composite, etc., any of which may be susceptible to bending, cracking, shattering, etc. when forcefully contacting an object (e.g., the ground during off-road use of the vehicle 24).

As shown in FIG. 1, the bumper cover 22 extends in the vehicle lateral direction Y across the vehicle 24 between a pair of cover ends 26. In embodiments, the bumper cover 22 may be formed as a one piece monolithic structure with the cover ends 26. The pair of reinforcement plates 20 are individually disposed at the pair of cover ends 26, thus protecting portions of the bumper cover 22 at the cover ends 26. The cover ends 26 of the bumper cover 22 may be more susceptible to contact with the ground during off road use as a suspension system of the vehicle 24 may allow the vehicle 24 to roll left and right about the vehicle longitudinal direction X of the vehicle 24.

Furthermore, the bumper cover 22 is spaced along the vehicle longitudinal direction X from rear wheels of the vehicle 24, which can cause the bumper cover 22 to become closer to the ground when the vehicle 24 rolls down an incline (e.g., forward movement) or up an incline (e.g., rearward movement). The roll of the vehicle 24 in conjunction with the placement of the bumper cover 22 relative to rear wheels increases the probability of the cover ends 26 contacting the ground in comparison to the remainder of the bumper cover 22. As such, the pair of replacement plates may provide targeted protection to the cover ends 26 of the bumper cover 22, which are susceptible to impact. It is to be appreciated that the pair of reinforcement plates 20 may be configured for use along any portion of the bumper cover 22. Furthermore, while the pair of reinforcement plates 20 are shown in FIG. 1, any number of reinforcement plates 20 may be utilized to protect any portion the bumper cover 22, including the entirety of the bumper cover 22.

As shown in FIG. 1, the vehicle 24 includes a chassis 28 having a pair of frame rails 30 extending generally parallel to one another along the vehicle longitudinal direction of the vehicle 24. The pair of reinforcement plates 20 are individually mounted to the pair of frame rails 30. The mounting of the pair of reinforcement plates 20 to the pair of frame rails 30 will be described in greater detail below.

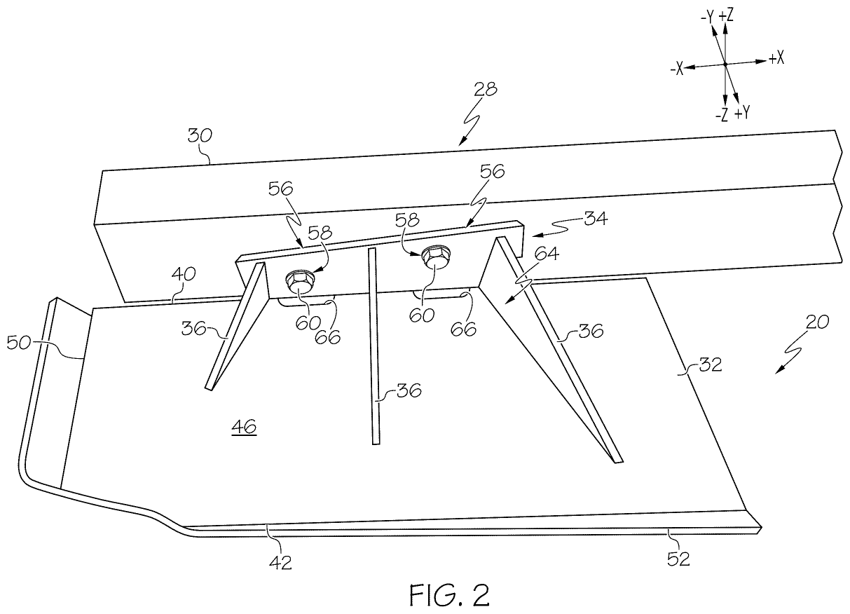

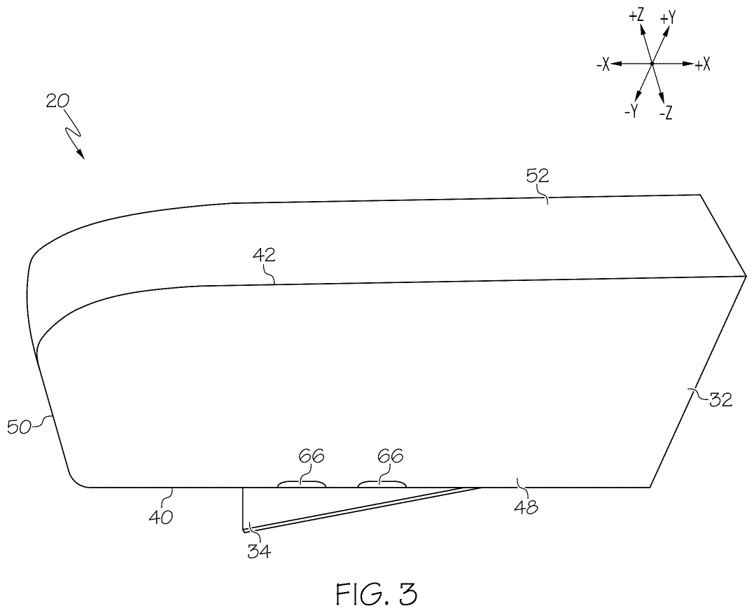

The pair of reinforcement plates 20 as shown in FIG. 1 are symmetrically identical to one another (e.g., mirror images of one another). The description below and FIGS. 2 and 3 describe/show one of the pair of reinforcement plates 20 (specifically, the reinforcement plate 20 disposed at the right-rear of the vehicle 24). However, the description of the reinforcement plate 20 below is directly applicable to the reinforcement plate 20 that is disposed at the left-rear of the vehicle 24.

As shown in FIG. 2, the reinforcement plate 20 includes a base wall 32 configured to be disposed below the bumper cover 22, a mounting bracket 34 extending from the base wall 32 and configured to be mounted to the chassis 28 of the vehicle 24, and a plurality of ribs 36 each extending between and connected to the base wall 32 and the mounting bracket 34 for supporting the position of the base wall 32 relative to the mounting bracket 34. In one embodiment, the reinforcement plate 20 is formed of steel. However, the reinforcement plate 20 may be formed another metal (e.g., aluminum), a composite, or any other material suitable for maintaining structural integrity upon impact and transmitting a load to the chassis 28 of the vehicle 24. Furthermore, the reinforcement plate 20 may be formed of more than one material. The base wall 32, the mounting bracket 34, and the plurality of ribs 36 may mounted to one another, by welding, chemical bonding, mechanical fastening, etc. Furthermore, the base wall 32, the mounting bracket 34, and the plurality of ribs 36 may be formed as a one piece monolithic structure by machining, additive manufacturing, stamping, etc.

The base wall 32 may be configured to cover at least a portion of a lower surface 38 of the bumper cover 22, as described above and shown in FIG. 1. The base wall 32 may extend in the vehicle lateral direction Y relative to the vehicle 24 between a first end 40 and a second end 42. The second end 42 is configured to be positioned adjacent a corner 44 of the vehicle 24. The corner 44 of the vehicle 24 corresponds to the cover end 26 of the bumper cover 22 as described above. As such, the reinforcement plate 20 covers a rear surface of the bumper cover 22 and a lateral surface of the cover ends 26. The base wall 32 may have an inner surface 46 (FIG. 2) configured to face the chassis 28 of the vehicle 24 and an outer surface 48 (FIG. 3) facing the ground. The inner surface 46 of the base wall 32 faces the lower surface 38 of the bumper cover 22.

As shown in FIGS. 2 and 3, the base wall 32 may extend in a substantially planar configuration to a perimeter edge 50 and may have a generally horizontal orientation that that may correspond to the orientation of the lower surface 38 of the bumper cover 22. Accordingly, the base wall 32 may be disposed substantially parallel to the lower surface 38 of the bumper cover 22. The base wall 32 may be spaced from the lower surface 38 of the bumper cover 22 to allow some deflection under load without contacting the lower surface 38 of the bumper cover 22. In one embodiment, the spacing between the base wall 32 and the lower surface 38 of the bumper cover 22 is between 2.5 mm and 15 mm. In another embodiment, the spacing between the base wall 32 and the lower surface 38 of the bumper cover 22 is between 5 mm and 10 mm.

The base wall 32 may be sized and shaped to correspond with the size and shape of the lower surface 38 of the bumper cover 22 and the cover ends 26, as shown in FIG. 1. More specifically, the perimeter edge 50 of the base wall 32 may follow the contours of the bumper cover 22 and cover ends 26 that are visible during normal operation of the vehicle 24 to maintain the general of aesthetics of the bumper cover 22. The base wall 32 may extend further into the vehicle 24 than the lower surface 38 in order to position the mounting bracket 34 and the reinforcing ribs 36 behind the bumper cover 22. It is to be appreciated that the base wall 32 may have any suitable size, shape, and configuration relative to the bumper cover 22.

As shown in FIGS. 2 and 3, the reinforcement plate 20 may further include a side wall 52 that bounds a portion of the perimeter edge 50 of the base wall 32. The side wall 52 extends transverse to the base wall 32 and is configured to extend upwardly relative to the vehicle 24 such that the side wall 52 covers at least a portion of an exterior side surface 54A of the bumper cover 22 and an exterior side surface 54B of the cover ends 26, as shown in FIG. 1. As such, the side wall 52 extends along the portion of the perimeter edge 50 that is adjacent the exterior side surface 54A of the bumper cover 22 and the exterior side surface 54B of the cover ends 26. However, the side wall 52 may extend along any suitable portion of the perimeter edge 50. Like the base wall 32 and the lower surface 38 of the bumper cover 22, the side wall 52 may be spaced from the exterior side surface 54A of the bumper cover 22 and the exterior side surface 54B of the cover ends 26 to allow some deflection under load without contacting the exterior side surface 54A of the bumper cover 22 or the exterior side surface 54B of the cover ends 26. In one embodiment, the spacing between the side wall 52 and the exterior side surface 54A of the bumper cover 22 and the exterior side surface 54B of the cover ends 26 is between 2.5 mm and 15 mm. In another embodiment, the spacing between the side wall 52 and the exterior side surface 54A of the bumper cover 22 and the exterior side surface 54B of the cover ends 26 is between 5 mm and 10 mm.

As shown in FIG. 1, the side wall 52 may cover a portion of the exterior side surface 54A of the bumper cover 22 and the exterior side surface 54B of the cover ends 26 that are adjacent the lower surface 38, with a greater portion of the exterior side surface 54A and the exterior side surface 54B of the cover ends 26 not covered by the side wall 52. In this embodiment, the side wall 52 provides protection to the bumper cover 22 generally around the lower surface 38 of the bumper cover 22 while providing some additional protection of the exterior side surface 54A of the bumper cover 22 and the exterior side surface 54B of the cover ends 26. However, the greater portion of the exterior side surface 54A of the bumper cover 22 and the exterior side surface 54B of the cover ends 26 are visible. Therefore, the side wall 52 minimally intrudes on the aesthetics of the exterior side surface 54A of the bumper cover 22 and the exterior side surface 54B of the cover ends 26.

As shown in FIG. 2, the mounting bracket 34 may extend substantially orthogonal to the base wall 32 and have a generally vertical orientation. Moreover, the mounting bracket 34 may be configured to extend upward relative to the vehicle 24, positioning the mounting bracket 34 adjacent the frame rail 30. Furthermore, the mounting bracket 34 may have a planar configuration. Therefore, the mounting bracket 34 may be configured to extend along a surface of the frame rail 30.

In the embodiment shown in FIG. 2, the first end 40 of the base wall 32 is positioned adjacent the frame rail 30. Therefore, the mounting bracket 34 is disposed adjacent the first end 40 of the base wall 32. However, the mounting bracket 34 may be disposed anywhere along the base wall 32. For example, the base wall 32 may extend in the lateral direction Y beyond the frame rail 30 to the first end 40 (e.g., the first end 40 of the base wall 32 may overhang the mounting bracket 34).

The mounting bracket 34 may include an attachment interface 56 spaced from the base wall 32 and configured to mount to the chassis 28 of the vehicle 24. In the embodiment shown in FIG. 2, the attachment interface 56 defines a pair of holes 58 each configured to receive a fastener 60 for engaging the chassis 28 and mounting the reinforcement plate 20 to the vehicle 24. More specifically, the frame rail 30 defines a pair of frame holes individually corresponding to the pair of the holes 58 of the mounting bracket 34. The fasteners 60 extend through the holes 58 of the mounting bracket 34 and the frame holes of the frame rail 30 so secure the mounting bracket 34 to the frame rail 30. The frame holes of the frame rail 30 may already exist for another purpose. For example, the frame holes may be used for mounting a tow hook, a hitch, etc. to the frame rail 30.

In the embodiment shown in FIG. 2, each of the fasteners 60 include a bolt and a nut configured to couple with the bolt. However, the fastener 60 may be a machine screw, a pin, or any other suitable fastener configuration for securing the mounting bracket 34 to the frame rail 30. In other embodiments, the frame rail 30 may not include the frame holes and the fasteners 60 may pierce the frame rail 30 (e.g., a self-tapping screw). Furthermore, the attachment interface 56 may include other configurations, other than the holes 58, for securing the mounting bracket 34 to the frame rail 30, including welding, tabs, rivets, posts, etc.

The base wall 32 and the mounting bracket 34 define a cavity 64 therebetween. The fasteners 60 may extend into or otherwise be accessible from the cavity 64. For example, when the fasteners 60 each include the bolt and the nut, a head of the bolt or the nut may be disposed in the cavity 64, each of which is typically engaged by a wrench. At least one of the base wall 32 and the mounting bracket 34 may define an aperture opening into the cavity 64 for accessing the fasteners 60 to assemble the reinforcement plate 20 to the vehicle 24. In the embodiment shown in FIGS. 2 and 3, the base wall 32 and the mounting bracket 34 collectively define a pair of apertures 66. The pair of apertures 66 are positioned individually below the mounting bracket 34 and between the plurality of ribs 36. The pair of apertures 66 are sized and shape to allow a wrench to be inserted into the cavity 64 to engage the fasteners 60, thereby allowing assembly and disassembly of the reinforcement plate 20 to the frame rail 30.

The plurality of ribs 36 may extend from the mounting bracket 34 along the inner surface 46 of the base wall 32 in the lateral direction Y toward the second end 42 of the base wall 32. One or more of the plurality of ribs 36 may extend in other directions. For example, in the embodiment shown in FIG. 2, one of the plurality of ribs 36 extends from the mounting bracket 34 toward both the second end 42 and the front of the vehicle 24. Another one of the plurality of ribs 36 extends from the mounting bracket 34 toward both the second end 42 and the rear of the vehicle 24. As such, the plurality of ribs 36 splay apart from and Provides support in the longitudinal direction X of the vehicle 24 to reduce rotation of the base wall 32 relative to the mounting bracket 34 about the lateral direction Y. It is to be appreciated that the plurality of ribs 36 may extend in any suitable direction for providing any desired reinforcement between the base wall 32 and the mounting bracket 34. Furthermore, while the plurality of the ribs 36 in the embodiment shown in FIG. 2 has three of the ribs 36, any number of ribs 36 may be utilized.

It should now be understood that embodiments of the present disclosure are directed to a reinforcement plate for protecting a bumper cover of a vehicle. The reinforcement plate serves as a barrier that prevents contact between the bumper cover and the ground during off-road use of the vehicle. The reinforcement plate includes a base wall configured to be disposed below the bumper cover and a mounting bracket extending from the base wall and configured to be mounted to a chassis of the vehicle. The reinforcement plate further includes a plurality of ribs each extending between and connected to the base wall and the mounting bracket for supporting the position of the base wall relative to the mounting bracket. The mounting of the reinforcement plate to the chassis creates a load path directly to the chassis, reducing a load experienced by the bumper cover when contact is made with the ground. Furthermore, the reinforcement plate is smaller and lighter than a steel bumper that replaces the bumper cover, which reduces the overall weight of the vehicle and allows the bumper cover to continue to be used. Moreover, the size of the reinforcement plate allows it to be installed and removed based on need. Said differently, the reinforcement plate may be installed for off-road use and then removed after off-road use. Furthermore, the placement of the base wall of the reinforcement plate under the bumper cover allows the bumper cover to be visible and maintain the aesthetic qualities of the vehicle.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A reinforcement plate for protecting a bumper cover of a vehicle, the reinforcement plate comprising:
a base wall configured to be disposed below the bumper cover;
a mounting bracket extending from the base wall and configured to be mounted to a chassis of the vehicle; and
a plurality of ribs each extending between and connected to the base wall and the mounting bracket for supporting a position of the base wall relative to the mounting bracket.

2. The reinforcement plate of claim 1, wherein the base wall extends in a substantially planar configuration to a perimeter edge and has a generally horizontal orientation, the base wall configured to cover at least a portion of a lower surface of the bumper cover.

3. The reinforcement plate of claim 2, wherein the mounting bracket extends substantially orthogonal to the base wall and has a generally vertical orientation, the mounting bracket configured to extend upward relative to the vehicle.

4. The reinforcement plate of claim 2, further comprising a side wall that bounds a portion of the perimeter edge of the base wall, the side wall extending transverse to the base wall and configured to extend upwardly relative to the vehicle such that the side wall covers at least a portion of an exterior side surface of the bumper cover.

5. The reinforcement plate of claim 1, wherein the mounting bracket comprises an attachment interface spaced from the base wall and configured to mount to the chassis of the vehicle.

6. The reinforcement plate of claim 5, wherein the attachment interface defines at least two holes each configured to receive a fastener for engaging the chassis and mounting the reinforcement plate to the vehicle.

7. The reinforcement plate of claim 6, wherein the base wall and the mounting bracket define a cavity therebetween, and at least one of the base wall and the mounting bracket defines an aperture opening into the cavity for accessing the fasteners to assemble the reinforcement plate to the vehicle.

8. The reinforcement plate of claim 1, wherein the base wall extends in a lateral direction relative to the vehicle between a first end and a second end, the second end configured to be positioned adjacent a corner of the vehicle.

9. The reinforcement plate of claim 8, wherein the mounting bracket is disposed adjacent the first end of the base wall.

10. The reinforcement plate of claim 8, wherein the base wall has an inner surface configured to face the chassis of the vehicle, the plurality of ribs extending from the mounting bracket along the inner surface of the base wall toward the second end.
